(19) United States
(12) Patent Application Publication
(10) Pub. No.: US 2009/0127736 A1
(43) Pub. Date: May 21, 2009

(54) SOLUTION CASTING METHOD AND SOLUTION CASTING APPARATUS

(76) Inventors: Takuro NISHIMURA, Kanagawa (JP); Hidekazu Yamazaki, Kanagawa (JP)

Correspondence Address: BIRCH STEWART KOLASCH & BIRCH, PO BOX 747, FALLS CHURCH, VA, 22040-0747, US

(21) Appl. No.: 12/271,691

(22) Filed: Nov. 14, 2008

(30) Foreign Application Priority Data
Nov. 16, 2007 (JP) 2007-297706

(51) Int. Cl. B29C 39/14; B29C 39/22

(52) U.S. Cl. 264/212; 425/223; 425/71

(57) ABSTRACT

A casting film is formed by releasing a casting dope onto a moving circumferential surface. The casting film is cooled to obtain self supporting property. A peel roller peels the casting film as a primary wet film and sends the primary wet film to a transfer section. Through the transfer section and the like, the primary wet film is guided to a first drying chamber where a wet gas containing water vapor is blown onto the primary wet film. Water molecules are absorbed in the primary wet film. Absorption of the water molecules in the primary wet film promotes diffusion of the constituent compounds contained in the primary wet film, which facilitates release of constituent compounds.

### FIELD OF THE INVENTION

The present invention relates to a solution casting method and a solution casting apparatus.

### BACKGROUND OF THE INVENTION

A polymer film (hereinafter referred to as film) has advantages such as excellent light transmission properties and flexibility, and is easy to be made lighter and thinner. Accordingly, the film is widely used as an optical functional film. As a representative of the film, a cellulose triacetate (TAC) film using cellulose acylate (especially, cellulose triacetate (TAC) with an average acetylation degree in the range of 57.5 to 62.5%) has toughness and flame retardancy, and therefore the TAC film is utilized as a film base of photosensitive material. Additionally, since the TAC film has an excellent optical isotropy, the TAC film is utilized as an optical functional film such as a protective film for a polarizing filter, an optical compensation film, and a wideview film in a LCD and the like whose market is increasingly expanding.

As a film production method, mainly, there are a melt-extrusion method and a solution casting method. In the melt-extrusion method, a polymer is heated to be melted, and then extruded by an extruder, to form a film. The melt-extrusion method has advantages such as high productivity and relatively low equipment cost. However, in the melt-extrusion method, it is difficult to adjust thickness accuracy of the film, and fine streaks (die lines) easily occur on the film. Accordingly, it is difficult to produce a film having high quality as an optical functional film. On the other hand, in the solution casting method, a polymer solution (hereinafter referred to as a dope) containing a polymer and a solvent is cast onto a support to form a casting film. The casting film obtains self-supporting property, and peeled from the support to form a wet film. The wet film is dried and wound as a film. In the solution casting method, it is possible to obtain a film having more excellent optical isotropy and thickness evenness and containing less foreign substances in comparison with the melt-extrusion method. Therefore, the solution casting method is adopted as a producing method of a film, in particular, an optical functional film (see, for example, Japanese Patent Laid-Open Publication No. 2006-306052).

A sharp increase in demand for the LCD devices requires a solution casting method with high production efficiency. In the solution casting method, most of the time in the film production is used in a drying process. To increase the production efficiency, reduction of the drying time is considered.

According to the solution casting method disclosed in Japanese Patent Laid-Open Publication No.2006-306052, the drying time is reduced to a certain extent by regulating the surface temperature of the wet film responsive to the degree of the drying of the wet film. However, it is difficult to remove the solvent deep inside a thick film only by regulating the surface temperature of the wet film. As a result, it has been impossible to reduce the drying time. A long drying time is a serious problem especially when the thickness of the wet film exceeds 100 μm.

To remove the solvent deep inside the thick wet film, it is known to dry the wet film at a higher temperature. However, such high drying temperature may cause thermal decomposition of a polymer as a raw material of the film, and results in deterioration of optical and mechanical properties of the film. Therefore, there are limitations in efficiently producing the film with the thickness above a certain value based on the solution casting method of Japanese Patent Laid-Open Publication No. 2006-306052 and other well known arts.

### SUMMARY OF THE INVENTION

In view of the above, an object of the present invention is to provide a solution casting method and a solution casting apparatus for producing a film efficiently.

In a solution casting method of the present invention, a first compound contained in the solvent is eliminated from the wet film by drying the wet film with gas containing a second compound. The second compound has a higher boiling point than the first compound.

In a case where the solvent contains plural compounds, it is preferable that the compound having the highest boiling point among the plural compounds to be eliminated is defined as the first compound. The gas preferably contains the second compound having at least 0.3 MS and at most 1 MS where MS is an amount of saturated vapor in the second compound. It is preferable that the temperature of the gas is at least BP and at most 3 BP where BP (unit: ° C.) is a boiling point of the second compound.

It is preferable that the first compound contains at least one of dichloromethane, methanol, and ethanol, and that the second compound contains at least one of water, methanol, acetone, methyl ethyl ketone, and butanol.

It is preferable that the drying step is performed after the wet film is dried using a tenter drier. It is preferable that heated gas is blown onto the wet film for further drying the wet film after the drying step.

In a solution casting method of the present invention, at least one of the casting film and the wet film is contacted with a liquid. The casting film and the wet film contain a first compound contained in the solvent. The liquid contains a second compound having a higher boiling point than the first compound. After being contacted with the liquid, the first compound is eliminated from the wet film by drying the wet film. Thus, a film is formed.

A solution casting apparatus of the present invention includes a support, a peeling device, and a drying device. A casting film containing a polymer and a solvent is formed on the support. The peeling device peels the casting film as a wet film from the support. The drying device eliminates a first compound contained in the solvent from the wet film by drying the wet film with gas containing a second compound. The second compound has a higher boiling point than the first compound. It is preferable that the drying device includes a plurality of rollers for conveying the wet film, a drying chamber in which the rollers are housed, and a gas supplying unit for circulating the gas to and from the drying chamber. It is preferable that the solution casting apparatus further includes a tenter dryer disposed upstream from the drying device. The tenter dryer holds side edge portions of the wet film and conveys the wet film while blowing the gas onto the wet film. It is preferable that the solution casting apparatus further includes a heated-gas drying device disposed downstream from the drying device. The heated-gas drying device blows heated gas onto the wet film after the wet film passes through the drying device.

According to the solution casting method of the present invention, the first compound contained in the solvent is eliminated from the wet film with the gas containing the second compound. The second compound has higher boiling point than the first compound. As a result, the residual first compound in the wet film is easily diffused toward the vicinity of the surface of the wet film where evaporation is active so that the solvent is eliminated easily. According to the present invention, diffusion of the residual first compound in the wet film is enhanced without drying in the high temperature range. Therefore, the film is produced efficiently while avoiding thermal decompression of the polymer molecules or the like.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanatory view of a dope production line for producing a primary dope;

FIG. 2 is an explanatory view of a film production line;

FIG. 3 is an explanatory view of an embodiment of the film production line;

FIG. 4 is an explanatory view of a first drying process in a first drying chamber;

FIG. 5 is explanatory view of an embodiment of a wet gas supplying device;

FIG. 6 is a graph showing correlation between a drying time and a residual solvent amount when the casting film is dried to produce a film;

FIG. 7 is an explanatory view of another embodiment of the wet gas supplying device;

FIG. 8 is an explanatory view of the first drying process in a transfer section; and

FIG. 9 is an explanatory view of an essential part of the second embodiment of the film production line.

### DESCRIPTION OF THE PREFERRED EMBODIMENTS

Embodiments of the present invention are described hereinbelow. The present invention, however, is not limited to the following embodiments.

(Polymer)

Cellulose acylate is used as a polymer in this embodiment. Especially preferable cellulose acylate is cellulose triacetate (TAC). In the cellulose acylate, it is preferable that the degree of the acyl substitution for hydrogen atoms in hydroxyl groups in cellulose satisfies all of the following formulae (I) to (III):

2.5≦A+B≦3.0 (I)

0≦A≦3.0 (II)

0≦B≦2.9 (III)

In the above formulae (I) to (III), “A” represents a degree of substitution of the hydrogen atom in the hydroxyl group to the acetyl group in cellulose, while “B” represents a degree of substitution of the hydrogen atom in the hydroxyl group to the acyl group with 3 to 22 carbon atoms in cellulose. Preferably, at least 90 wt % of TAC particles has a diameter in the range of 0.1 mm to 4 mm. Note that, the polymer capable of being used in the present invention is not limited to cellulose acylate.

Cellulose has glucose units making β-1,4 bond, and each glucose unit has a free hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DSG/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, one or more kinds of the acyl groups may be contained in cellulose acylate. In a case where two or more kinds of acyl groups are in cellulose acylate, it is preferable that one of them is the acetyl group. In a case where a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88. In addition, DSB is preferably at least 0.30, and more preferably at least 0.7. In the DSB, the percentage of the substitution of the hydroxyl group at the sixth position is at least 20%, preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared, especially when a non-chlorine organic solvent is used. With the use of the non-chlorine organic solvent, the solution has low viscosity and excellent filterability.

Cellulose as a material of cellulose acylate may be obtained from either linter or pulp.

According to the present invention, as for cellulose acylate, the acyl group having at least 2 carbon atoms maybe either aliphatic group or aryl group, and is not especially limited. Examples of the cellulose acylate include alkylcarbonyl ester, alkenylcarbonyl ester, aromatic carbonyl ester, aromatic alkylcalbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

(Solvent)

Examples of solvents to be used for preparing the dope include aromatic hydrocarbon (for example, benzene, toluene, and the like), halogenated hydrocarbon (for example, dichioromethane, chlorobenzene, and the like), alcohol (for example, methanol, ethanol, n-propanol, n-butanol, diethylene glycol, and the like), ketone (for example, acetone, methyl ethyl ketone, and the like), ester (for example, methylacetate, ethylacetate, propylacetate, and the like), ether (for example, tetrahydrofuran, methyl cellosolve, and the like), and the like. Note that in the present invention the dope means a polymer solution or dispersion solution that is obtained by dissolving or dispersing the polymer in the solvent.

The halogenated hydrocarbon preferably has 1 to 7 carbon atoms, and dichloromethane is most preferable. In view of physical properties of the TAC, such as solubility, peelability of a casting film from the support, a mechanical strength of the film, and optical properties of the film, it is preferable to use at least one kind of alcohol having 1 to 5 carbon atoms together with dichioromethane. The content of alcohol is preferably in the range of 2 wt % to 25 wt %, and more preferably in the range of 5 wt % to 20 wt % relative to the whole solvent. Examples of alcohols include, for example, methanol, ethanol, n-propanol, iso-propanol, n-butanol, and the like, and especially methanol, ethanol, n-butanol, and a mixture of them are preferably used.

Recently, in order to reduce adverse influence on the environment to the minimum, the use of a solvent containing no dichloromethane is examined in this case, the solvent preferably contains ether with 4 to 12 carbon atoms, ketone with 3 to 12 carbon atoms, ester with 3 to 12 carbon atoms, alcohol with 1 to 12 carbon atoms, or a mixture of them. For example, a solvent mixture may contain methylacetate, acetone, ethanol, and n-butanol. Note that ether, ketone, ester, and alcohol may have a cyclic structure. A compound having at least two functional groups thereof (that is, —O—, —CO—, —COO—, and —OH) may be used as the solvent.

Details of cellulose acylate are described in paragraphs [0140] to [0195] in Japanese Patent Laid-Open Publication No. 2005-104148. Such description is also applicable to the present invention. In addition, the solvent and the additives (such as a plasticizer, a deterioration inhibitor, a UV-absorbing agent, an optical anisotropy controller, a retardation controller, dye, a matting agent, a release agent, a release improver, and the like) are also detailed in paragraphs [0196] to [0516] in the same publication.

(Dope Producing Method)

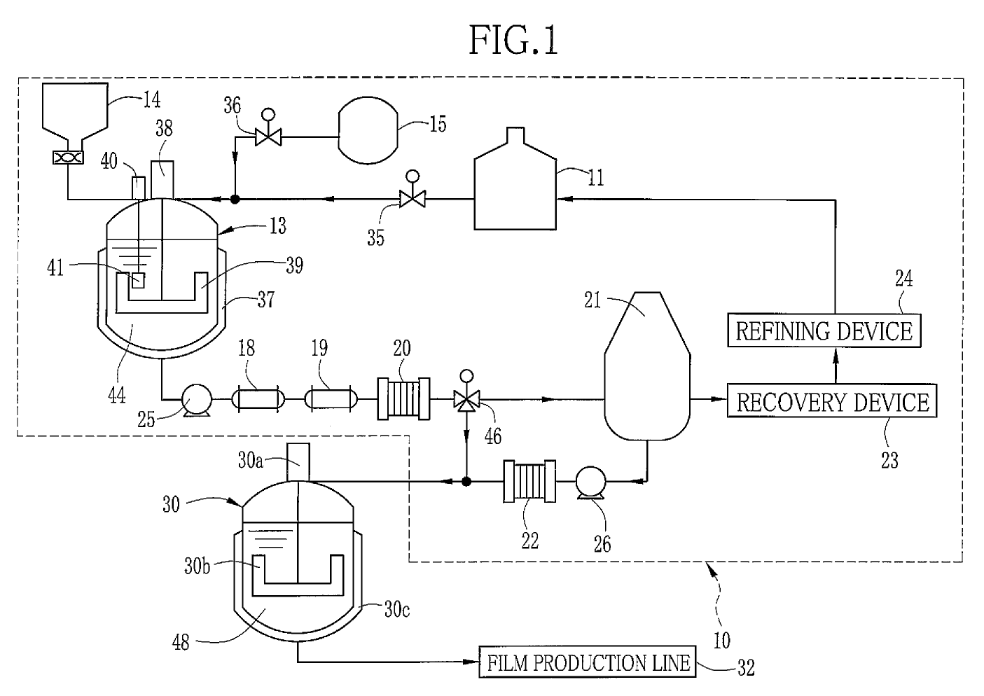

In FIG. 1, a dope production line 10 is provided with a solvent tank 11, a mixing tank 13, a hopper 14, an additive tank 15, a heater 18, a temperature regulator 19, a filtration device 20, a flash device 21, and a filtration device 22. The solvent tank 11 stores a solvent. The hopper 14 supplies the TAC to the mixing tank 13. The solvent is mixed with TAC and the like in the mixing tank 13. The additive tank 15 stores a liquid additive. The heater 18 heats a swelling liquid, which will be described later. The temperature regulator 19 regulates the temperature of the prepared dope. The dope is filtered through the filtration device 20. The dope is condensed in the flash device 21. The condensed dope is filtered through the filtration device 22. Additionally, the dope production line 10 is provided with a recovery device 23 for recovering the solvent and a refining device 24 for refining the recovered solvent. A pump 25 is provided downstream from the mixing tank 13. A pump 26 is provided downstream from the flash device 21. The pump 25 feeds a swelling liquid 44 in the mixing tank 13 to the heater 18. The pump 26 feeds the condensed dope in the flash device 21 to the filtration device 22. A stock tank 30 is connected downstream from the filtration devices 20 and 22. The dope production line 10 is connected to a film production line 32 through the stock tank 30.

First, a valve 35 is opened to feed the solvent from the solvent tank 11 to the mixing tank 13. The valve 35 is provided in piping connecting the solvent tank 11 and the mixing tank 13. Next, the TAC in the hopper 14 is fed to the mixing tank 13 while being measured. A valve 36 is opened and closed to feed a necessary amount of an additive solution from the additive tank 15 to the mixing tank 13. The valve 36 is provided in piping connecting the additive tank 15 and the mixing tank 13. It is possible to feed the additive in other forms. For example, in a case where the additive is in a liquid state at room temperature, the additive can be fed to the mixing tank 13 in the liquid state. In a case where the additive is in a solid state, it is possible to use the hopper 14 or the like to feed the additive to the mixing tank 13. To add several kinds of additives, it is possible to put the solution in which the several kinds of additives are dissolved in the additive tank 15. Also, plural additive tanks 15 each containing a different additive solution can be used. The additive solution can be fed from each additive tank 15 to the mixing tank 13 through piping independent from each other.

In the above description, the solvent (including the solvent mixture), the TAC and the additive are put into the mixing tank 13 in this order. However, the order is not limited to the above. The proper amount of the solvent can be fed to the mixing tank 13 after the TAC is fed to the mixing tank 13. The additive is not necessarily put in the mixing tank 13 in advance. The additive may be mixed to the mixed compound of the TAC and the solvent in a later process.

The mixing tank 13 is provided with a jacket 37 for covering an outer surface thereof, and a first stirrer 39 rotated by a motor 38. It is preferable to attach a second stirrer 41 rotated by a motor 40 to the mixing tank 13. It is preferable that the first stirrer 39 has an anchor blade, and the second stirrer 41 is of a dissolver type. It is preferable to regulate the temperature inside the mixing tank 13 in a range of −10° C. and 55° C. by passing the heat transfer medium inside the jacket 37. The swelling liquid 44, in which the TAC is swelled in the solvent, is obtained by selecting and rotating the first stirrer 39 and the second stirrer 41 as necessary.

The swelling liquid 44 is fed to the heater 18 through the pump 25. It is preferable to use a tube with the jacket for the heater 18, and it is more preferable that the tube has a structure to pressurize the swelling liquid 44. The dope is prepared by dissolving the TAC in the solvent of the swelling liquid 44 while the swelling liquid 44 is heated or heated and pressurized. In this case, it is preferable that the temperature of the swelling liquid 44 is at least 0° C. and at most 97° C. The TAC is sufficiently mixed to or dissolved in the solvent by using a heat dissolution method and/or a cool dissolution method as necessary. After the temperature of the dope is adjusted approximately to room temperature by the temperature regulator 19, impurities in the dope are removed by filtering the dope through the filtration device 20. An average pore diameter of a filter of the filtration device 20 is preferably at most 100 μm. A filtration flow volume is preferably at least 5 L/hr. After the filtration, the dope is put in the stock tank 30 through a valve 46.

The above described dope can be used as a primary dope, which will be described later. However, the above method in which the TAC is mixed or dissolved after the preparation of the swelling liquid 44 is more time-consuming as the concentration of the TAC increases, resulting in higher costs. To prevent such problems, it is preferable to perform a concentration process in which the dope of the intended TAC concentration is prepared by concentrating the dope of a lower TAC concentration. The dope filtered through the filtration device 20 is fed to the flash device 21 through the valve 46. A part of the solvent in the dope is evaporated in the flash device 21. The solvent vapor is condensed and liquefied in the condenser (not shown), and then recovered by the recovery device 23. It is advantageous, in terms of cost, to refine the recovered solvent and reuse it as the solvent for the dope preparation.

The concentrated dope is extracted from the flash device 21 through the pump 26. It is preferable to remove foam from the dope. Any known method can be used for removing the foam, for example, an ultrasonic irradiation method. Thereafter, impurities are removed from the dope through the filtration device 22. At this time, the temperature of the dope is preferably at least 0° C. and at most 200° C. The filtered dope is stored in the stock tank 30.

Thus, the dope is produced having the TAC concentration within a predetermined range. A produced dope (hereinafter referred to as primary dope) 48 is stored in the stock tank 30.

In the dope production line 10, TAC is used as a polymer for the preparation of the primary dope 48. In the present invention, cellulose acylate other than TAC may be used as a polymer.

Materials, raw materials, dissolution methods of the additives, filtration methods, defoaming methods, and addition methods used in the above described dope production line 10 are detailed in paragraphs from [0517] to [0616] of the Japanese Patent Laid-Open Publication No. 2005-104148, and these descriptions may be applied to the present invention.

(Film Producing Process)

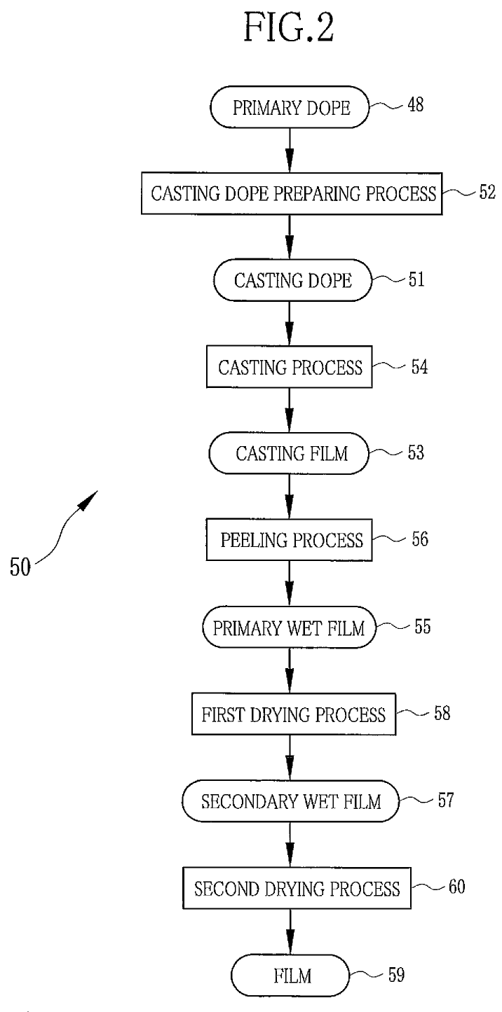

Next, a film producing process 50 of the present invention is described. As shown in FIG. 2, the film producing process 50 has a casting dope preparing process 52, a casting process 54, a peeling process 56, a first drying process 58, and a second drying process 60. In the casting dope preparing process 52, a casting dope 51 is prepared from the above described primary dope 48. In the casting process 54, the casting dope 51 is cast onto a moving support to form a casting film 53. In the peeling process 56, the casting film 53 is peeled off from the support as a primary wet film 55 when the casting film 53 obtains the self supporting property. In the first drying process 58, a residue of a compound constituting the solvent (hereinafter referred to as constituent compound) in the primary wet film 55 is released (evaporated) by contacting the primary wet film 55 with a first dry gas containing a compound (hereinafter referred to as high boiling point compound) having a higher boiling point than the constituent compound. Thereby, the primary wet film 55 is referred to as a secondary wet film 57. In the second drying process 60, the secondary wet film 57 is contacted with a second dry gas, which releases the residual high boiling point compound and the constituent compound in the secondary wet film 57. Thus, a film 59 is produced. A winding process maybe performed after the second drying process 60. In the winding process, the film 59 is wound into a film roll.

(Solution Casting Apparatus)

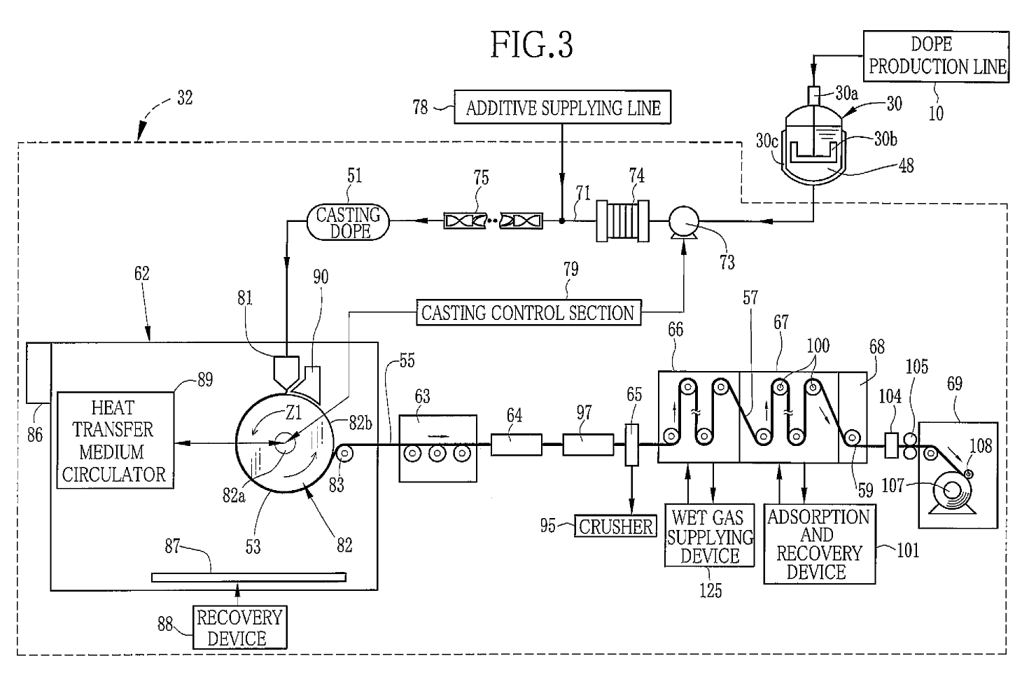

In FIG. 3, the film production line 32 has a casting chamber 62, a transfer section 63, a pin tenter 64, an edge-slitting device 65, a first drying chamber 66, a second drying chamber 67, a cooling chamber 68, and a winding chamber 69.

The stock tank 30 is provided with a stirring blade 30b rotated by a motor 30a, and a jacket 30c provided around an outer periphery of the stock tank 30. The primary dope 48, namely, the raw material of the film 59, is stored in the stock tank 30. The inner temperature of the stock tank 30 is kept approximately constant by the jacket 30c, and the stirring blade 30b is rotated. Thus, coagulation of the polymer is prevented and the quality of the primary dope 48 is kept uniform.

The stock tank 30 and the casting chamber 62 are connected through piping 71. The piping 71 is provided with a gear pump 73, a filtration device 74, and an inline mixer 75. In the upstream from the inline mixer 75, an additive supplying line 78 is connected to the piping 71. The additive supplying line 78 supplies, to the primary dope 48 in the piping 71, predetermined amounts of an UV absorbent, additive(s) such as a matting agent and/or retardation agent, or a polymer solution containing these UV absorbent and the additives (hereinafter referred to as additive mixture). The inline mixer 75 stirs and mixes the primary dope 48 and the additive mixture to prepare the casting dope 51.

The gear pump 73 is connected to a casting control section 79. Under the control of the casting control section 79, the gear pump 73 feeds the casting dope 51 to a casting die 81 at a predetermined flow volume. The casting die 81 is disposed in the casting chamber 62.

The casting chamber 62 is provided with the casting die 81, a casting drum (hereinafter referred to as drum) 82, a peel roller 83, a temperature regulator 86, a condenser 87, and a recovery device 88. The casting dope 51 is cast from the casting die 81 onto the drum 82 as a support to form the casting film 53. The peel roller 83 peels the casting film 53 from the drum 82. The temperature regulator 86 keeps the inner temperature of the casting chamber 62 within a predetermined range. The condenser 87 condenses and liquefies the solvent vapor in the casting chamber 62. The liquefied solvent is recovered by the recovery device 88. The recovered solvent is refined and then reused as a solvent for the dope preparation. Thus, the recovery device 88 keeps solvent vapor pressure of the solvent contained in the atmosphere of the casting chamber 62 within a predetermined range.

(Casting Die)

The casting die 81 has a die slit across its lower end for casting the casting dope 51 onto a circumferential surface 82b of the drum 82 disposed below the die slit. Here, the casting dope 51 between the die slit and the circumferential surface 82b is referred as a casting bead. The casting dope 51 on the circumferential surface 82b is referred to as the casting film 53.

Precipitation hardened stainless steel is preferable as the material for the casting die 81. The material preferably has a coefficient of thermal expansion at most 2×10⁻⁵(° C.⁻¹). Further, the material with the almost same anti-corrosion properties as SUS31G in examination of corrosion in electrolyte solution can also be used. Further, the material has the anti-corrosion property such that pitting is not formed on the gas-liquid interface after the material has been dipped in a liquid mixture of dichloromethane, methanol and water for three months. Further, it is preferable to manufacture the casting die 81 by grinding the material which passed more than a month after casting. Thereby, the casting dope 51 flows through the casting die 81 uniformly. Accordingly, streaks and the like in the casting film are prevented, as will be described later. It is preferable that the finish precision of a contacting surface of the casting die 81 to the dope is at most 1 μm of the surface roughness, and the straightness is at most 1 μm/m in any direction. Clearance of the die slit is automatically controlled in a range of 0.5 mm and 3.5 mm. An end of the contacting portion of each lip of the casting die 81 to the dope is processed so as to have a chamfered radius of at most 50 μm throughout the die slit. Further, it is preferable to adjust the shearing speed in the casting die 81 in a range of 1 (1/sec) to 5000 (1/sec). With the use of such casting die 81, the uniform casting film 53 with no streaks is formed on the circumferential surface 82b of the drum 82. A width of the casting die 81 is not particularly limited. However, the width of the casting die 81 is preferably in a range of 1.1 times to 2.0 times larger than a width of the film as an end product. Further, it is preferable to install a temperature regulator (not shown) to the casting die 81 for maintaining a predetermined temperature during the production of the film. Further, the casting die 81 is preferably of a coathanger type. It is preferable that the casting die 81 is provided with bolts (heat bolts) at predetermined intervals in the width direction of the casting die 81 for adjusting the thickness of the film, and an automatic thickness control mechanism using the heat bolts. It is preferable that a profile responsive to the flow volume of the gear pump 73 is set with the use of the heat bolts, based on the previously set program. In addition, a feedback control may be performed by an adjustment program based on a profile of an infrared thickness gauge (not shown) disposed in the film production line 32. It is preferable that a difference in the thickness between two arbitrary points in the product film (excluding the edge portions of the product film) is adjusted to be at most 1 μm. The difference between the maximum value and the minimum value of the thickness in the width direction is preferably at most 3 μm and more preferably at most 2 μm. It is preferable that the variation in the thickness of the film is adjusted to be at most ±1.5 μm.

It is more preferable that lip ends of the casting die 81 are provided with a hardened layer. Methods to provide the hardened layer are not limited. For example, there are methods of ceramic coating, hard chrome plating, nitriding treatment and the like. In a case where the ceramics is used as the hardened layer, the ceramic which is grindable but not friable with a lower porosity and the good corrosion resistance is preferred. The ceramic which sticks to the casting die 81 but does not stick to the casting dope 51 is preferable. For example, tungsten carbide (WC), Al₂O₃, TiN, Cr₂O₃ and the like can be used, and especially WC is preferable. A WC coating is performed in a spraying method.

(Drum)

Below the casting die 81, the drum 82 is provided. The drum 82 has an approximate cylindrical shape or an approximate tubular shape. The drum 82 has a shaft 82a connected to the casting control section 79. Under the control of the casting control section 79, the drum 82 rotates about the shaft 82a, which moves the circumferential surface 82b in a moving direction Z1.

A heat transfer medium circulator 89 is attached to the drum 82 to keep the temperature of the circumferential surface 82b of the drum 82 approximately constant within a predetermined range. A heat transfer medium, kept at a predetermined temperature by the heat transfer medium circulator 89, passes through a heat transfer medium flow path inside the drum 82 to keep the circumferential surface 82b within the predetermined temperature range.

A width of the drum 82 is not particularly limited. It is preferred that the width of the drum 82 is in a range of 1.1 times to 2.0 times larger than the width of the casting dope 51. The circumferential surface 82b is polished such that its surface roughness is at most 0.01 μm. It is necessary to keep the surface defects on the circumferential surface 82b to a minimum. Specifically, the number of pin holes whose diameter is not less than 30 μm is preferably zero. The number of pinholes whose diameter is not less than 10 μm and less than 30 μm is preferably at most one per 1 m². The number of pinholes whose diameter is less than 10 μm is at most two per 1 m². The position fluctuation of the circumferential surface 82b in the up and down directions associated with the rotation of the drum 82 is preferred to be at most 200 μm. It is preferred that at most 3% of the rotation speed of the drum 82 is permitted as speed fluctuation. The position fluctuation of the drum 82 in the width direction per rotation is preferred to be at most 3 mm.

It is preferred that the material of the drum 82 is stainless steel, and more preferably SUS 316 which offers sufficient corrosion resistance and strength. It is preferred that the circumferential surface 82b of the drum 82 is chromeplated, which provides the corrosion resistance and the strength sufficient for casting the casting dope 51.

(Peel Roller)

The peel roller 83 is disposed downstream from the casting die 81 with respect to the rotating direction Z1, and in the vicinity of the circumferential surface 82b of the drum 82. The peel roller 83 peels the casting film 53 on the drum 82, and the peeled casting film is referred to as the primary wet film 55.

A decompression chamber 90 is disposed upstream from the casting die 81 with respect to the moving direction Z1, and in the vicinity of the circumferential surface 82b. The decompression chamber 90 is connected to the control section (not shown). Under the control of the control section, the decompression chamber 90 reduces a pressure of an area upstream from the casting bead by at least 10 Pa and at most 2000 Pa relative to the pressure of an area downstream from the casting bead. It is preferred to attach a jacket (not shown) to the decompression chamber 90 to keep the inner temperature at a predetermined value. The inner temperature of the decompression chamber 90 is not particularly limited, but preferred to be higher than the condensation temperature of the solvent contained in the dope.

In the downstream of the casting chamber 62, the transfer section 63, the pin tenter 64, and the edge-slitting device 65 are disposed in this order. The primary wet film 55 is dried in the transfer section 63 and the pin tenter 64.

The transfer section 63 is provided with a plurality of rollers and the like, which guide the primary wet film 55 sent from the casting chamber 62.

The pin tenter 64 has a plurality of pins to hold the primary wet film 55. The pins are attached to each of endless loop-like chains. The pins move responsive to the movement of the chains. In the pin tenter 64, the side edge portions of the primary wet film 55 are pierced and held by the pins, and then conveyed responsive to the movement of the chains. The pin tenter 64 is provided with a dry air supplying device (not shown), which circulates the dry air with predetermined conditions inside the pin tenter 64, or blows such dry air onto the primary wet film 55 for drying.

The edge slitting device 65 is provided between the pin tenter 64 and the first drying chamber 66. The edge slitting device 65 is provided with a crusher 95. The edge slitting device 65 cuts off the side edge portions of the primary wet film 55, and the cut-off portions are sent to the crusher 95. The crusher 95 pulverizes the cut-off portions into film chips. The film chips are reused as a raw material for the primary dope 48.

A clip tenter 97 may be provided between the pin tenter 64 and the edge slitting device 65. The clip tenter 97 is a drying device having clips as a holding device to hold the primary wet film 55. In the clip tenter 97, the primary wet film 55 is dried and stretched in the width direction or in the conveying direction in a state that both side edge portions of the primary wet film 55 are held. Stretching with a predetermined condition in the clip tenter 97 imparts desired optical properties to the primary wet film 55.

The first drying chamber 66 is provided with a plurality of rollers and the like that guide the primary wet film 55 sent from the edge slitting device 65. In the first drying chamber 66, the first dry gas is blown onto the primary wet film 55 guided by the rollers. Thereafter, the primary wet film 55 is referred to as the secondary wet film 57. The secondary wet film 57 is sent to the second drying chamber 67. The first drying chamber 66 will be detailed later.

The second drying chamber 67 is provided with a plurality of rollers 100 and an adsorption and recovery device 101. In addition, a compulsory neutralization device (neutralization bar) 104 is provided downstream from the cooling chamber 68 that is connected to the second drying chamber 67. In this embodiment, a knurling roller pair 105 is provided downstream from the compulsory neutralization device 104.

In the second drying chamber 67, the secondary wet film 57 is conveyed while being bridged over the rollers 100. In the second drying chamber 67, the constituent compound evaporated from the secondary wet film 57 is recovered by the adsorption and recovery device 101 together with the second dry gas. The adsorption and recovery device 101 adsorbs and recovers the constituent compound from the recovered second dry gas. After the removal of the constituent compound, gas is reused as the second dry gas in the second drying chamber 67. It is more preferable that the second drying chamber 67 is divided into several sections to change the drying temperature in each section. A predry chamber (not shown) may be provided between the first drying chamber 66 and the second drying chamber 67 to predry the secondary wet film 57. Thereby, abrupt increase in the temperature of the secondary wet film 57 is prevented. Thus, changes in shapes of the secondary wet film 57 or the film 59 are prevented.

The cooling chamber 68 cools the secondary wet film 57 to approximately room temperature. A moisture control chamber (not shown) may be provided between the second drying chamber 67 and the cooling chamber 68. In the moisture control chamber, air controlled at desired temperature and humidity is blown onto the secondary wet film 57. Thereby, curls and winding defects of the secondary wet film 57 are prevented. The secondary wet film 57 is discharged from the cooling chamber 68 as the film 59 and sent to the compulsory neutralization device 104.

The compulsory neutralization device 104 controls charged voltage of the film 59 which is being conveyed within a predetermined range (for example, −3 kV to +3 kV). The knurling roller pair 105 provides knurling to the side edge portions of the film 59. It is preferred that the height of the knurling is at least 1 μm and at most 200 μm.

A winding roller 107 and a press roller 108 are provided inside the winding chamber 69. The winding roller 107 winds the film 59 at a predetermined winding speed, while applying desired tension to the film 59 using the press roller 108.

(First Drying Chamber)

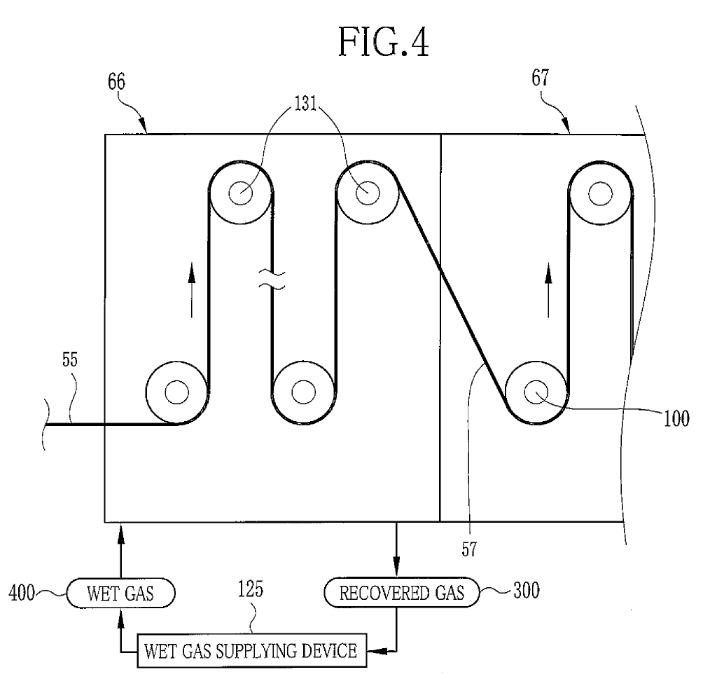

As shown in FIG. 4, the first drying chamber 66 has a plurality of rollers 131 arranged in a staggered arrangement. The rollers 131 guide the primary wet film 55 sent from the edge slitting device 65 to the second drying chamber 67. The first drying chamber 66 is provided with a gas inlet (not shown) and a gas outlet (not shown). The first drying chamber 66 is connected to a wet gas supplying device 125 through the gas inlet and the gas outlet. The wet gas supplying device 125 recovers the first dry gas from the first drying chamber 66 as recovered gas 300 through the gas outlet. The wet gas supplying device 125 generates wet gas 400 having predetermined conditions, and supplies the wet gas 400 as the first dry gas to the first drying chamber 66 through the gas inlet.

(Wet Gas Supplying Apparatus)

Next, the wet gas supplying device 125 is detailed.

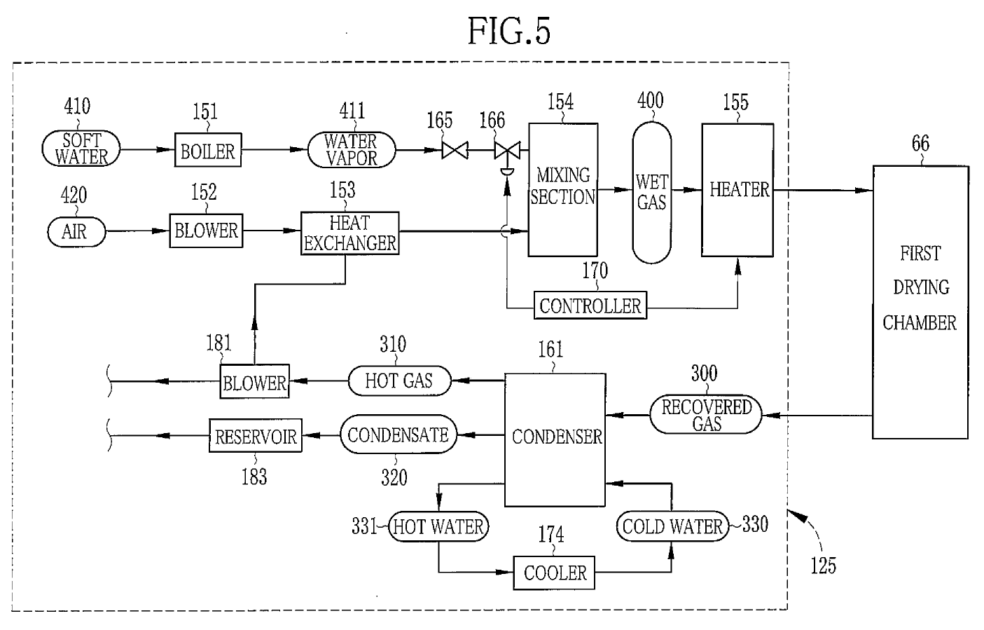

As shown in FIG. 5, the wet gas supplying device 125 has a boiler 151, a blower 152, a heat exchanger 153, a mixer 154, a heater 155, and a condenser 161. The boiler 151 heats soft water 410 to generate water vapor 411. The blower 152 supplies dry air 420. The heat exchanger 153 heats the air 420 supplied by the blower 152. The mixer 154 mixes the air 420 from the heat exchanger 153 and the water vapor 411 to generate the wet gas 400. The heater 155 heats the wet gas 400 and feeds the heated wet gas 400 to the first drying chamber 66. The condenser 161 condenses the recovered gas 300 recovered from the first drying chamber 66 to generate hot gas 310 and a condensate 320.

The piping to connect the boiler 151 and the mixer 154 is provided with a pressure reducing valve 165 and a flow control valve 166. The pressure reducing valve 165 reduces the pressure of the water vapor 411 to a predetermined value. The flow control valve 166 adjusts the flow volume of the water vapor 411. A controller 170 connects the flow control valve 166 and the heater 155. The controller 170 controls the flow volume and the temperature of the wet gas 400. The flow volume and the temperature of the wet gas 400 may be controlled based on a value M1 measured by a sensor (not shown) provided to the gas inlet, the gas outlet or the like, or on a value M1 responsive to the production conditions in the solution casting method. The value M1 is a mass of water molecules contained in the wet gas 400 per unit volume.

The condenser 161 is connected to a cooler 174. The cooler 174 supplies cold water 330 to the condenser 161. The cold water 330 is used for condensation of the recovered gas 300. After being used for the condensation of the recovered gas 300, the cold water 330 becomes hot water 331. The cooler 174 cools the recovered hot water 331 and supplies the cooled water as the cold water 330 to the condenser 161.

The blower 181 sends part of the hot gas 310 generated in the condenser 161 to the heat exchanger 153 to reuse heat. The redundant hot gas 310 is discarded.

The condensate 320, namely, the condensed water, the condensed solvent, or the mixture of them is sent to a reservoir 183. The storage tank is provided with a concentration sensor that detects concentration of the solvent. The condensate 320 is discarded after predetermined processing.

Next, an example of a method for producing the film 59 using the above described film production line 32 is described. As shown in FIG. 3, the primary dope 48 in the stock tank 30 is constantly kept uniform by the rotation of the stirring blade 30b. Additives such as a plasticizer may be added to the primary dope 48 during the stirring. A heat transfer medium is supplied inside the jacket 30c to keep the temperature of the primary dope 48 approximately constant within a range of 25° C. and 35° C.

Under the control of the casting control section 79, the gear pump 73 feeds the primary dope 48 to the piping 71 through the filtration device 74. The primary dope 48 is filtered through the filtration device 74. The additive supplying line 78 feeds the additive mixture containing the matting agent, the UV agents and the like to the piping 71. The inline mixer 75 stirs and mixes the primary dope 48 and the additive mixture. Thus, the casting dope 51 is prepared in the inline mixer 75, it is preferred to keep the temperature of the primary dope 48 approximately constant within a range of 30° C. and 40° C. A mixing ratio of the primary dope 48, the matting agent and the UV absorbent is not particularly limited. However, the mixing ratio is preferably within a range of 90 wt. %: 5 wt. %: 5 wt. % and 99 wt. %: 0.5 wt. %: 0.5 wt. %. The casting dope 51 is fed to the casting die 81 in the casting chamber 62 through the gear pump 73.

The recovery device 88 keeps the vapor pressure of the solvent vapor contained in the atmosphere of the casting chamber 62 approximately constant within a predetermined range. The temperature regulator 86 keeps the temperature of the atmosphere in the casting chamber 62 approximately constant in a range of at least −10° C. and at most 57° C.

Under the control of the casting control section 79, the drum 82 rotates about the shaft 82a, which moves the circumferential surface 82b at a predetermined speed (at least 50 m/min and at most 200 m/min) in the moving direction Z1. The heat transfer medium circulator 89 keeps the temperature of the circumferential surface 82b approximately constant in a range of −10° C. and 10° C.

The casting die 81 casts the casting dope 51 from the die slit to the circumferential surface 82b. The casting film 53 is formed on the circumferential surface 82b. The casting film 53 is cooled on the circumferential surface 82b and thereby gelation is promoted. As a result, the casting film 53 exhibits self-supporting property and solidified enough to be peeled.

Thereafter, the casting film 53 is peeled as the primary wet film 55 from the circumferential surface 82b while being supported by the peel roller 83. The peel roller 83 guides the primary wet film 55 to the transfer section 63. In the transfer section 63, the dry gas controlled at a predetermined condition is blown onto the primary wet film 55.

After passing through the transfer section 63, the primary wet film 55 is guided to the pin tenter 64. In the pin tenter 64, side edge portions of the primary wet film 55 are supported by a film supporting device such as pins. With the use of such film supporting device, the primary wet film 55 is conveyed through the pin tenter 64 while being dried under a predetermined condition. After being released from the film supporting device, the primary wet film 55 is sent to the clip tenter 97. At the entrance of the clip tenter 97, the side edge portions of the primary wet film 55 are held by the film holding device such as clips. The primary wet film 55 is dried while being conveyed by the film holding device through the clip tenter 97. During the conveyance, the primary wet film 55 is stretched in a predetermined direction by the film holding device.

The primary wet film 55 is dried in the clip tenter 97 or the like until the primary wet film 55 reaches a predetermined residual solvent amount. Thereafter, the primary wet film 55 is sent to the edge slitting device 65, which cuts the side edge portions of the primary wet film 55. The cut-off side edge portions are sent to the crusher 95 using the cutter blower (not shown), and then pulverized by the crusher 95 into film chips. The film chips are reused for preparation of the dope.

Thereafter, the primary wet film 55 is sent to the first drying chamber 66. In the first drying chamber 66, the primary wet film 55 is subjected to the first drying process 58. Thereby, the primary wet film 55 is referred to as the secondary wet film 57. The secondary wet film 57 is guided to the second drying chamber 67. The first drying process 58 in the first drying chamber 66 will be detailed later.

In the second drying chamber 67, the secondary wet film 57 is subjected to the second drying process 60. In the second drying process 60, the secondary wet film 57 is dried upon contact with the second dry gas, and thus the film 59 is produced. The second drying process 60 in the second drying chamber 67 is detailed later. The temperature of the second dry gas in the second drying chamber 67 is not particularly limited, but preferred to be at least 80° C. and at most 180° C., and more preferred to be 100° C. and 150° C.

When the second drying process 60 is ended, the residual solvent amount of the film 59 is preferred to be at most 5 wt. % in a dry basis. The weight percentage of the residual solvent content (dry basis) is an amount obtained by a mathematical expression {(x−y)/y}×100, where x is the weight of a sample film at the sampling, and y is the weight of the dried sample film. The film 59 is sufficiently dried, and then the film 59 is sent to the cooling chamber 68, where the film 59 is cooled to approximately room temperature.

During the conveyance, the compulsory neutralization device 104 keeps the charged voltage of the film 59 within a predetermined range (for example in a range of −3 kV and +3 kV). The knurling roller pair 105 provides knurling to side edge portions of the film 59 by embossing. The film 59 is wound by the winding roller 107 inside the winding chamber 69 while predetermined tension is applied to the film 59 by the press roller 108. It is preferred to gradually change the winding tension from the start to the end of the winding.

It is preferred that the film 59 to be wound by the winding roller 107 has the length (in a casting direction) of at least 100 m. The width of the film 59 is preferred to be 600 mm, and more preferred to be at least 1400 mm and at most 2500 mm. The present invention is also effective on the film 59 with a width larger than 2500 mm.

It is preferred that the thickness of the film 59 is at least 20 μm and at most 200 μm, and more preferably at least 40 μm and at most 100 μm.

Next, the first drying process 58 is detailed.

As shown in FIG. 4, the wet gas supplying device 125 fills the first drying chamber 66 with the wet gas 400 adjusted to a predetermined condition. After being discharged from the edge slitting device 65, the primary wet film 55 is bridged across and conveyed by the rollers 131 to the second drying chamber 67. Thus, the first drying process 58 using the wet gas 400 with the predetermined condition is performed in the first drying chamber 66. After the first drying process 58, the primary wet film 55 is referred to as the secondary wet film 57.

In the first drying process 58 using the wet gas 400, water molecules contained in the wet gas 400 are absorbed in the primary wet film 55. This absorption of the water molecules makes the constituent compounds in the primary wet film 55 and in the secondary wet film 57 easy to diffuse, and such constituent compounds reach the vicinity of the surface of the primary wet film 55 and the secondary wet film 57. As a result, the residual constituent compounds are easily released from the primary wet film 55 and the secondary wet film 57 in the first drying process 58 and the second drying process 60. In the second drying process 60, upon contact with the second dry gas, water molecules, or water molecules together with the residual constituent compounds are released from the secondary wet film 57. In the secondary wet film 57, the water molecules are more easily diffused when compared to the constituent compounds. Therefore, it is easy to evaporate the water molecules even when the water molecules are away from the surface of the secondary wet film 57. With the first drying process 58 and the second drying process 60, the total drying processes are performed with a shorter time at a lower drying temperature compared to the conventional drying process using only the dry air.

The present invention is significantly effective in a case where the first drying process 58 is performed to the primary wet film 55 in a falling rate drying state. The falling rate drying state occurs after a constant rate drying state. The constant rate drying state is an initial stage of drying in which the release of the constituent compounds and the like from the vicinity of the surface of the primary wet film 55 or the secondary wet film 57 is predominant. Then, in the falling rate drying state, the release of the constituent compounds and the like inside (away from the surface of) the primary wet film 55 or the secondary wet film 57 after the constituent compounds are diffused toward the surface is predominant.

In the film producing process 50 (see FIG. 2), whether the primary wet film 55 is in the falling rate drying state or not is determined by, for example, (1) whether the residual solvent amount of the casting film 53 or the primary wet film 55 is within a predetermined range, or (2) defining that the primary wet film 55 peeled off from the support as the falling rate drying state.

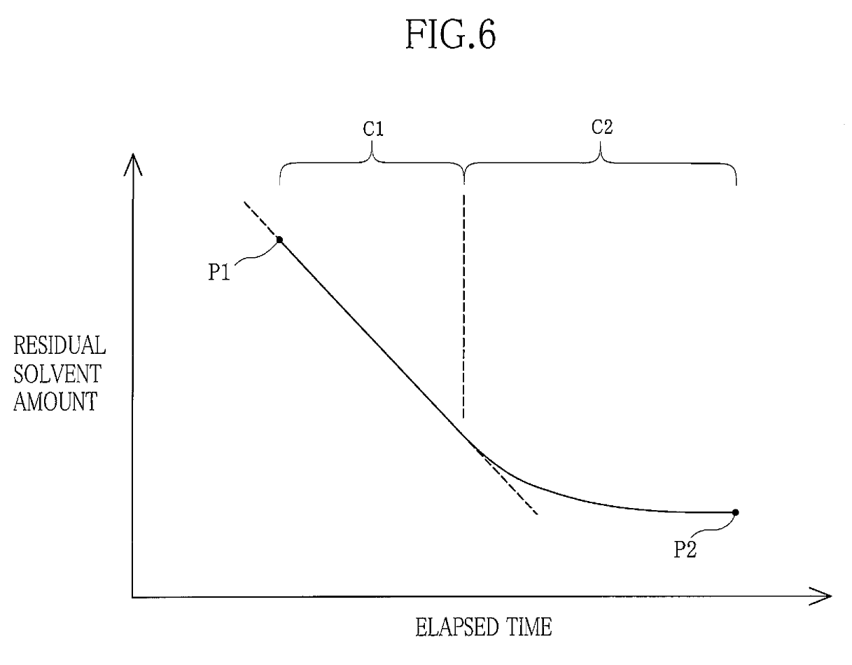

In the above determination method (1), a constant-rate drying state C1 is defined as a state in which a drying speed, shown as a gradient in a plot of FIG. 6, of the casting film 53 or the primary wet film 55 is approximately constant in a heating experiment under a given condition. In this case, the falling rate drying state C2 is defined as a state after the constant-rate drying state C1. The plot in FIG. 6 shows changes in the residual solvent amount with heating time (elapsed time) from the formation of the casting film 53 and until the production of the film 59.

It is preferred that the thickness of the primary wet film 55 which is to be subjected to the first drying process 58 is at least 30 μm, and more preferably at least 50 μm.

It is preferred that the wet gas 400 used in the first drying process 58 contains a larger number of water molecules, and has high temperature and high relative humidity. For efficient absorption of water molecules in the primary wet film 55, it is more preferred that the wet gas 400 has high temperature and high relative humidity.

When the amount of saturated vapor of water molecules in the wet gas 400 is denoted by MS, a mass M1 of the water molecules contained in the wet gas 400 is preferably at least 0.3 MS and at most MS, and more preferably at least 0.31 MS and at most 0.5 MS. In a case where the mass M1 of the water molecules contained in the wet gas 400 is less than 0.3 MS, a sufficient amount of water molecules is not absorbed in the primary wet film 55. As a result, the constituent compounds are not diffused to the vicinity of the surface of the primary wet film 55, and the drying efficiency is not improved, which is unfavorable.

The temperature of the wet gas 400 is preferably at least BP(° C.) and at most 3 BP(° C.), more preferably at least BP(° C.) and at most 2 BP(° C.), and most preferably at least 1.1 BP (° C.) and at most 1.7 BP (° C.) where the boiling point of the high-boiling compound is denoted by BP(° C.). When the temperature of the wet gas 400 exceeds the melting point of the polymer molecules, thermal decomposition of the polymer molecules occur, resulting in degradation of optical and mechanical properties, which is unfavorable.

Although water is used as the high boiling point compound in the above embodiment, the present invention is not limited thereto. The high boiling point compound refers to a compound having a higher boiling point than the constituent compound constituting the solvent contained in the casting dope 51.

When the high boiling point compound has compatibility with the solvent, the constituent compound is more easily diffused in the primary wet film 55 due to dissolution of the high boiling point compound, which is preferable.

In a case where a compound that does not have compatibility with the polymer, for example, water, is used as the high boiling point compound, it is necessary to perform the first drying process 58 without condensing the high boiling point compound onto the primary wet film 55. In other words, when water is used as the high boiling point compound, the temperature of the primary wet film 55 is set higher than a dew point of the wet gas 400 during the first drying process 58. This is because condensation of water molecules in the casting film 53 and the primary wet film 55 adversely affect the shapes and conditions, for example, surface smoothness, of the film as a product.

In a case where the solvent contained in the casting dope 51 consists of a single compound, the single compound is referred to as the constituent compound. In a case where the solvent contained in the casting dope 51 is a mixture of plural compounds, the compound with the highest boiling point among the compounds to be eliminated is referred to as the constituent compound.

Although water is used as the high boiling point compound in the above embodiment, the present invention is not limited thereto. Organic compounds, a mixture of organic compounds and water, or a mixture of plural organic compounds may be used as the high boiling point compound.

Although the water, namely, the high boiling point compound, is the soft water, the present invention is not limited thereto. Hard water or pure water may be used. The soft water is preferred in view of protection of the boiler 151. Admixture of foreign substances in the primary wet film 55 causes degradation in optical and mechanical properties of the film 59 as the product. Therefore, it is preferable to use water with a minimum amount of foreign substances. Therefore, in view of preventing admixture of foreign substances in the primary wet film 55, the high boiling point compound is preferably soft water or pure water, and more preferably pure water.

The pure water used in the present invention has electrical resistivity of at least 1 MΩ. The concentration of metal ion such as natrium ion, kalium ion, magnesium ion, and calcium ion contained in the pure water is less than 1 ppm, and the concentration of anion such as chlorine ion and nitric acid ion contained in the pure water is less than 0.1 ppm. The pure water can be easily obtained by reverse osmosis membrane, ion exchange resin, distillation, or combination of them.

Organic compound used as the high boiling compound is methanol, acetone, methyl ethyl ketone, butanol or the like.

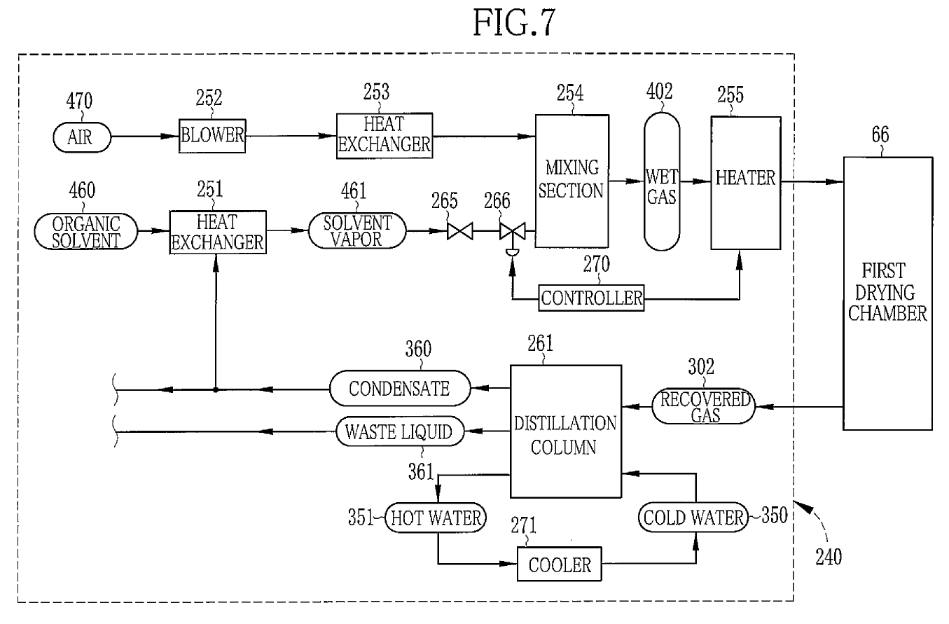

To use the organic compound as the high boiling point compound, a wet gas supplying device 240 shown in FIG. 7 may be used instead of the wet gas supplying device 125. The wet gas supplying device 240 has a heat exchanger 251, a blower 252, a heat exchanger 253, a mixing device 254, a heater 255, and a distillation column 261. In the heat exchanger 251, an organic solvent 460 that is the organic compound is heated to generated solvent vapor 461. The blower 252 feeds dry air 470 to the heat exchanger 253. In the heat exchanger 253, the dry air 470is heated. In the mixing device 254, the dry air 470 passed through the heat exchanger 253 and the solvent vapor 461 are mixed to generate wet gas 402. The heater 255 heats the wet gas 402 and then sends the wet gas 402 to the first drying chamber 66. The distillation column 261 condenses recovered gas 302 recovered from the first drying chamber 66 into a condensate 360 and a waste liquid 361. Here, the wet gas 402 refers to moistureless air containing the organic compound.

Piping connecting the heat exchanger 251 and the mixing device 254 is provided with a pressure reducing valve 265 and a flow control valve 266. The pressure reducing valve 265 reduces the pressure of the solvent vapor 461 to a predetermined value. The flow control valve 266 regulates the flow volume of the solvent vapor 461. A controller 270 connects the flow control valve 266 and the heater 255. The controller 270 regulates the flow volume and the temperature of the wet gas 402 based on the value M1.

A cooler 271 is connected to the distillation column 261. The cooler 271 supplies cold water 350 to the distillation column 261, where the cold water 350 is used for condensation of the recovered gas 302. The cold water 350 becomes hot water 351 after being used for the condensation of the recovered gas 302. The cooler 271 cools down the recovered hot water 351 into the cold water 350, and supplies the cold water 350 to the distillation column 261. Part of the condensate 360 generated in the distillation column 261 is sent to the heat exchanger 251 so as to reuse heat. The redundant condensate 360 and other waste liquid 361 are discarded after predetermined processing.

The wet gas supplying device 240 recovers the gas in the first drying chamber 66 as the recovered gas 302, and supplies the wet gas 402 adjusted to satisfy a predetermined condition to the first drying chamber 66. In the first drying chamber 66, the first drying process 58 (see FIG. 2) is performed with the use of the wet gas 402.

Although the dry air 420 and 470 are used in the above embodiment, the present invention is not limited thereto. Inert gas such as nitrogen, He or Ar may be used instead of the dry air 420, and 470. As with the high boiling point compound, the amount of impurities contained in the air 420 is preferably at the minimum.

Although a zone drying is performed with the use of the wet gas 400 in the first drying chamber 66 in the above embodiment, the present invention is not limited thereto. A drying method for blowing the wet gas 400, a well-known drying method, or a combination of them may be performed in the first drying process 58.

Although the first drying process 58 is performed in the first drying chamber 66, the present invention is not limited thereto. Drying process similar to the first drying process 58 may be performed in the transfer section 63, the pin tenter 64, or the clip tenter 97.

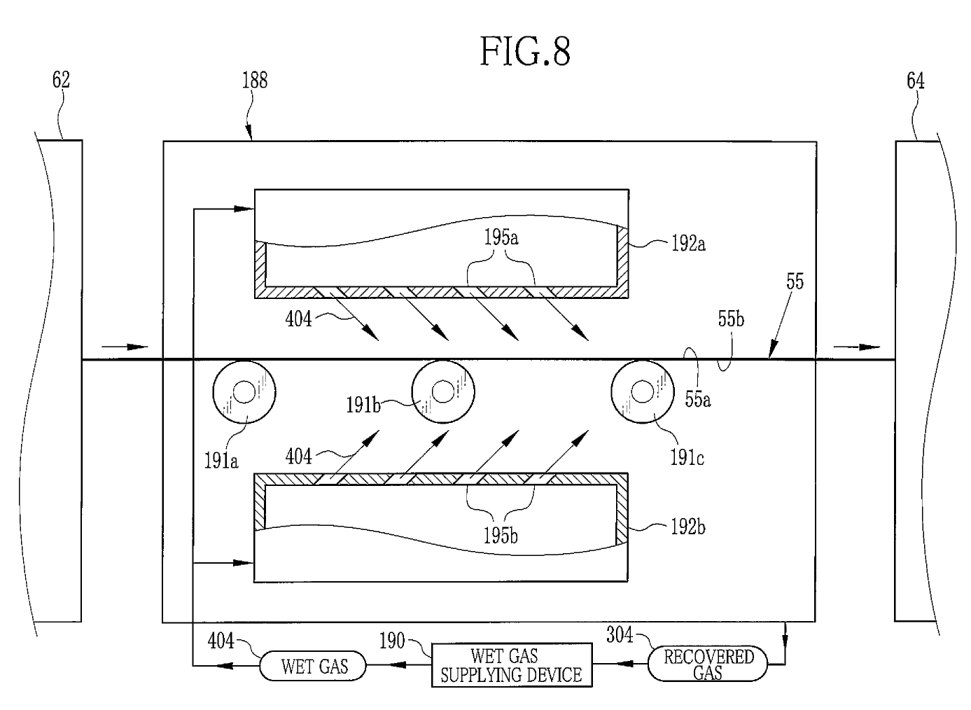

Next, a transfer section 188 for performing the first drying process 58 is described. As shown in FIG. 8, the transfer section 188 has rollers 191a to 191c, and gas supply ducts 192a and 192b. The rollers 191a to 191c guide the primary wet film 55 discharged from the casting chamber 62 to the pin tenter 64. The gas supply ducts 192a and 192b and a ventilation duct (not shown) provided in the transfer section 188 are connected to a wet gas supplying device 190. The wet gas supplying device 190 has a similar configuration to the above described wet gas supplying device 125. The wet gas supplying device 190 generates wet gas 404 adjusted at a predetermined condition and feeds the wet gas 404 to the gas supply ducts 192a and 192b, and recovers the air inside the transfer section 188 as the recovered gas 304. The gas supply duct 192a has a slit 195a through which the wet gas 404 is supplied. In the same way, the gas supply duct 192b has a slit 195b through which the wet gas 404 is supplied. The gas supply duct 192a is disposed such that the slit 195a faces a surface (hereinafter referred to as peel surface) 55a of the primary wet film 55. The peel surface 55a is a surface contacted with the circumferential surface 82b before peeling.

The wet gas supplying device 190 blows the wet gas 404 adjusted at a predetermined condition onto a the primary wet film 55 through the gas supply ducts 192a and 192b to dry the primary wet film 55.

Although the gas supply ducts 192a and 192b are used for blowing the wet gas 404 onto the primary wet film 55 in the transfer section 188 in the above embodiment, the present invention is not limited thereto. An intake duct to recover the wet gas 404 blown onto the primary wet film 55 may also be used in addition to the gas supply ducts 192a and 192b.

Although the solution casting method in which the casting film 53 obtains the self-supporting property by cooling on the drum 82 is described in the above embodiment, the present invention is not limited thereto. The present invention is also effective in a solution casting method in which the casting film 53 is dried to be hardened. In addition, the present invention is applicable to a solution casting method using a casting belt that is looped around and moved by rollers instead of the drum 82.

In the above embodiment, the first drying process 58 is performed using the wet gas 400 containing the soft water 410. Alternatively, a liquid containing a high boiling point compound such as the soft water 410 may be contacted with the casting film 53 or the primary wet film 55. In view of simplification of the producing processes and producing apparatuses, the above described embodiment is preferable. However, similar effect can be achieved by contacting the liquid to the casting film 53 or the primary wet film 55. To contact the casting film 53 or the primary wet film 55 with the liquid, for example, the casting film 53 or the primary wet film 55 may be coated with the liquid or soaked in the liquid.

Next, another embodiment in which a liquid containing a high boiling point compound is contacted with the casting film 53 or the primary wet film 55 is described. A part or member identical to that in the above embodiment is designated by the same numeral as the above embodiment, and only the matters different from those in the above embodiment are detailed.

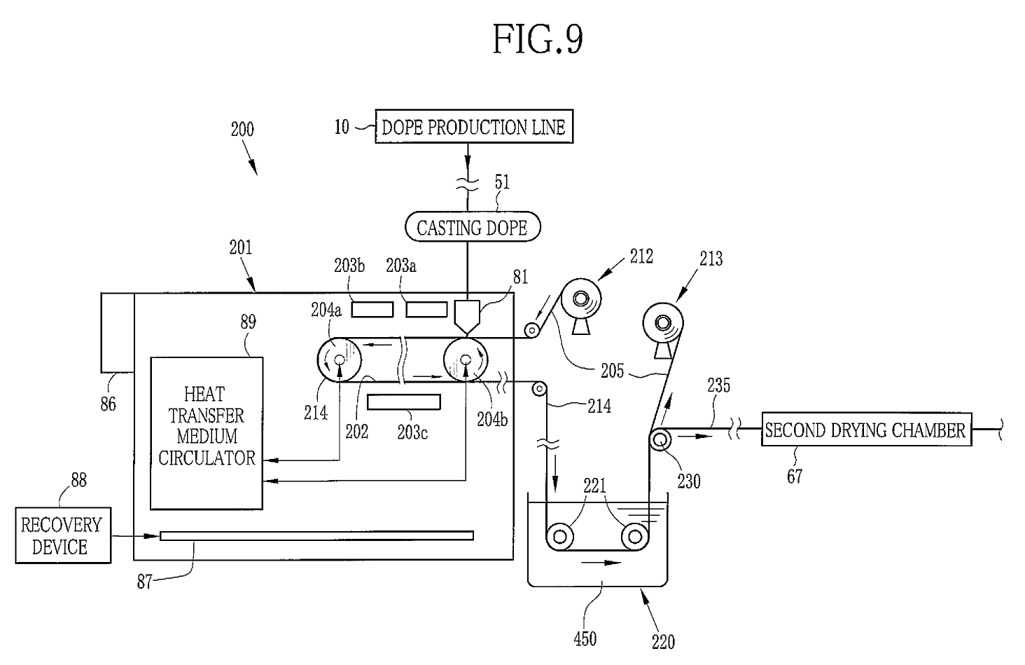

As shown in FIG. 9, the film production line 200 includes a casting chamber 201, the casting die 81, a belt 202, gas supply ducts 203a to 203c, and drums 204a and 204b. Similar to the above embodiment, the casting chamber 201 is provided with the temperature regulator 86, the condenser 87, the recovery device 88, and the heat transfer medium circulator 89. The belt 202 is looped around the drums 204a and 204b. Responsive to the rotation of the drums 204a and 204b, the belt 202 moves in a predetermined direction.

A web 205 in a roll form is set in a web feeder 212, and the web feeder 212 feeds the web 205 to the belt 202. The web 205 fed to the belt 202 is conveyed responsive to the movement of the belt 202, and wound by a web winding device 213.

In the vicinity of the drum 204b, the casting die 81 is set above the web 205. The casting die 81 casts the casting dope 51 on the surface of the moving web 205. The casting dope 51 on the web 205 is referred to as a casting film 214.

The gas supply ducts 203a to 203c are disposed in proximity to the web 205. The gas supply ducts 203a to 203c blow dry gas onto the casting film 214.

A bath 220 for storing a liquid 450 is provided between the drum 204b and the web winding device 213. A temperature regulator (not shown) keeps the temperature of the liquid 450 in the bath 220 approximately constant within a predetermined range. The liquid 450 contains the high boiling point compound.

The bath 220 has guide rollers 221. The guide rollers 221 guides the web 205 and the casting film 214 in the liquid 450, and then takes the web 205 and the casting film 214 out of the liquid 450.

A peel roller 230 is provided between the bath 220 and the web winding device 213. The casting film 214 is soaked in the liquid 450, and then peeled from the web 205 by the peel roller 230. Thereby, the casting film 214 is referred to as a wet film 235. The wet film 235 is sent to the transfer section 63.

In the film production line 200, the casting film 214 is contacted with the liquid 450 so that the casting film 214 absorbs the high boiling point compound. After passing through the transfer section 63 and the first drying chamber 66, the wet film 235 containing the high boiling point compound is subjected to a process similar to the second drying process 60 (see FIG. 2) in the second drying chamber 67 (see FIG. 3). Thereby, the constituent compounds contained in the wet film 235 are easily evaporated.

In the casting chamber 201, the casting film 214 maybe dried using the wet gas 400 instead of the dry gas.

In the solution casting method of the present invention, it is possible to simultaneously or sequentially co-cast two or more sorts of dopes. It is also possible to combine the simultaneous and sequential co-casting of the dopes. In the simultaneous co-casting, the casting die with a feed block or a multi-manifold type casting die can be used. In a multilayer film formed by the co-casting, it is preferable that one of two surface layers of the multilayer film preferably occupies in a range of 0.5% and 30% of the whole film thickness. Further, in the simultaneous co-casting, it is preferable that the higher viscosity dope covers over the low viscosity dope at the time of casting the casting dope 51 through the die slit. Further, in the casting bead formed between the die slit and the support, it is preferable that the dope contacting the air has a higher composition ratio of the alcohol than that of the inner dope.

Next, examples of the present invention are described. Hereinafter, example 1 is described in detail, and in examples 2 to 10 and comparative examples 1 to 5, the descriptions under the same conditions as in the example 1 are omitted, and only those different from the example 1 are described.

### EXAMPLE 1

Next, the example 1 of the present invention is explained. A composition of a polymer solution (dope) used in the film production is shown below.

[Preparation of the Dope]

A composition of a compound used in the preparation of the primary dope 48 was as follows:

| | |
|---|---|
| a solid content (solute) constituted of | 89.3 wt. % |
| cellulose triacetate (substitution degree of 2.8) | |
| plasticizer A (triphenyl phosphate) | 7.1 wt. % |
| plasticizer B (biphenyldiphenyl phosphate) | 3.6 wt. % |
| was added as necessary to a solvent mixture constituted of | 80 wt. % |
| dichloromethane | |
| methanol | 13.5 wt. % |
| n-butanol | 6.5 wt. % |

and stirred and mixed to prepare the primary dope 48. A TAC concentration of the primary dope 48 was adjusted to be 23 wt. % approximately. The primary dope 48 was filtered through a filter paper (No. 63LB, a product of Toyo Roshi Kaisha, Ltd.), and then through a sintered metal filter (06N, a product of Nippon Seisen Co., Ltd., nominal pore diameter of 10 μm), and thereafter through a mesh filter. Thereafter, the primary dope 48 was put in the stock tank 30.

[Cellulose Triacetate]

Cellulose triacetate used in this example contained the following: remaining content of acetic acid was at most 0.1 mass %, Ca content was 58 ppm, Mg content was 42 ppm, Fe content was 0.5 ppm, free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract in which TAC is extracted by acetone was 8 mass %, and a ratio of weight-average molecular weight to number-average molecular weight was 2.5. Further, yellow index was 1.7, haze was 0.08, and transparency was 93.5%. This cellulose triacetate was synthesized from cellulose obtained from cotton.

[Preparation of Matting Agent]

A matting agent having the following composition was prepared.

| | |
|---|---|
| Silica (AEROSIL R972, a product of NIPPON AEROSIL | 0.67 wt. % |
| Co., Ltd.) | |
| Cellulose acetate | 2.93 wt. % |
| Triphenyl phosphate | 0.23 wt. % |
| Biphenyl diphenyl phosphate | 0.12 wt. % |
| Dichloromethane | 88.37 wt. % |
| Methanol | 7.68 wt. % |

The prepared matting agent was dispersed using an attritor such that the volume average particle diameter became 0.7 μm. Then, the matting agent was filtered through an Astropore filter (a product of FUJIFILM Corporation). Thereafter, the matting agent was put in a tank for storing the matting agent.

[Preparation of UV Absorbent]

The UV absorbent having the following composition was prepared.

| | | |
|---|---|---|
| 2(2′-hydroxy-3′,5′-di-tert-butylphenyl)-5-chlorobenzotriazol | 5.83 | wt. % |
| 2(2′-hydroxy-3′,5′-di-tert-amylphenyl)benzotriazol | 11.66 | wt. % |
| Cellulose triacetate | 1.48 | wt. % |
| Triphenylphosphate | 0.12 | wt. % |
| Biphenyl diphenyl phosphate | 0.06 | wt. % |
| Dichloromethane | 74.38 | wt. % |
| Methanol | 6.47 | wt. % |

The prepared UV absorbent was filtered through the Astropore filter (a product of FUJIFILM Corporation) and put into a tank for storing the UV absorbent.

The film 59 was produced using the film production line 32. The gear pump 73 had a function to increase its upstream pressure. A feedback control to the upstream from the gear pump 62 was carried out by the inverter motor so as to keep the upstream pressure at 0.8 MPa. The gear pump 62 had the volume efficiency of 99.2%, and the fluctuation ratio of the discharge amount was at most 0.5%. Under the control of the casting control section 79, the gear pump 73 fed the primary dope 48 to the inline mixer 75. The filtration device 74 filtered the primary dope 48.

In the additive supplying line 78, the matting agent solution (a liquid matting agent) was mixed into an UV absorbent solution (a liquid matting agent) with the inline mixer to obtain an additive mixture. The additive supplying line 78 fed the additive mixture in the piping 71. The inline mixer 75 stirred and mixed the primary dope 48 and the additive mixture, and thus the casting dope 51 was obtained.

The casting die 81 was used as a discharging device. The casting die 81 was formed of precipitation hardened stainless steel. The variation in the volume was 0.002%. The finish precision of a contacting surface of the casting die 81 to the dope was at most 1 μm in the surface roughness, and the straightness was at most 1 μm/m in any direction. To regulate the temperature of the casting dope 51 at approximately 34° C., a jacket (not shown) was provided in the casting die 81, and the temperature of the heat transfer medium supplied inside the jacket was regulated.

The temperatures of the casting die 81 and the piping 71 during the film production was insulated at approximately 34° C.

With the use of the temperature regulator 86, the temperatures of the casting die 81 and the piping 71 were insulated at approximately 34° C. The casting die 81 was a coathanger type die. The casting die 81 was provided with bolts (heat bolts) at the intervals of 20 mm in the width direction of the casting die 81 for adjusting the thickness of the film, and an automatic thickness control mechanism using the heat bolts. With the use of the heat bolts, a profile responsive to the flow volume of the gear pump 73 can be set based on the previously set program. In addition, a feedback control can be performed by an adjustment program based on a profile of an infrared thickness gauge (not shown) disposed in the film production line 32. A difference in the thickness between two arbitrary points in the product film (excluding the edge portions each of which had a width of 20 mm) was adjusted to be at most 1 μm, and the difference between the maximum value and the minimum value of the thickness in the widthwise direction was at most 3 μm/m in the width direction. The variation in the thickness of the film was adjusted to be at most ±1.5%.

The casting process was performed using the casting die 81 to form a film having a width within a range of 1600 mm to 2500 mm, and the thickness TH1 of 60 μm.

The decompression chamber 90 was disposed upstream from the casting die 81 with respect to the moving direction of the drum 82. The decompression degree of the decompression chamber 90 was adjusted such that the difference between the upstream and the downstream from the casting bead was in a range of 1 Pa and 5000 Pa. The adjustment of the decompression degree was adjusted in accordance with the casting speed. The pressure difference between the upstream and the downstream from the casting bead was adjusted so as to make the length of the casting bead in a range of 20 mm and 50 mm. A jacket (not shown) was attached to the decompression chamber so as to keep the inner temperature of the decompression chamber constant. The heat transfer medium adjusted at approximately 35° C. was supplied to the inside of the jacket. The decompression chamber 90 was provided with a mechanism capable of setting the temperature of the decompression chamber 90 higher than the condensation temperature of the gas at the vicinity of the casting portion. The longitudinal sides of the slit of the casting die 81 were provided with a labyrinth packing (not shown).

The material for the casting die 81 was precipitation hardened stainless steel. A coefficient of thermal expansion thereof was at most 2×10⁻⁵(° C.⁻¹). The material had resistance to corrosion substantially equivalent to that of SUS316 subjected to a compulsory corrosion examination using an electrolyte aqueous solution. Further, the material had resistance to corrosion such that pitting (holes) was not caused on a gas-liquid interface after being soaked in a mixed liquid of dichloromethane, methanol, and water for three months. Accuracy of finishing of a contact surface between the casting die 81 and the liquid was at most 1 μm in the surface roughness, and straightness thereof was at most 1 μm/m in any direction. Slit clearance was adjusted at 1.5 mm. With respect to a corner portion of a lip edge of the casting die 81, which contacted with liquid, a chamfered radius R thereof was adapted to be at most 50 μm in the entire width. Shearing speed for the casting dope 51 inside the casting die 81 was adjusted in the range of 1(1/sec) to 5000 (1/sec). A hardened film was formed on the lip edge of the casting die 81 by performing WC coating with use of a thermal spraying method.

A stainless cylinder having a width of 3.0 m was used as the drum 82. The circumferential surface 82b of the drum 82 was ground such that the surface roughness became at most 0.05 μm. The drum 82 was made of SUS316 so as to have sufficient resistance to corrosion and strength. Moreover, unevenness in thickness of the drum 82 in the radial direction was at most 0.5%. The casting control section 79 causes the drum 82 to rotate by the driving of the shaft 82a. The moving speed of the circumferential surface 82b in the moving direction Z1 was set within the range of 50 m/min to 200 m/min. At this time, the speed fluctuation of the circumferential surface 82b was at most 0.5%. The side end positions of the drum 82 were detected to control the position fluctuation of the drum 82 in the width direction per rotation to be within 1.5 mm. Further, vertical position variation between the end of the die lip and the circumferential surface 82b just below the casting die 81 was at most 200 μm. The drum 82 was disposed in the casting chamber 62 provided with an air pressure controller (not shown).

The drum 82 was configured such that the heat transfer medium could be supplied to the inside of the drum 82 in order to control the temperature of the circumferential surface 82b. The heat transfer medium circulator 89 supplied the heat transfer medium at the temperature of at least −10° C. and at most 10° C. to the drum 82. The surface temperature of the center part of the drum 82 just before the casting was 0° C., and the difference in temperature between the side ends thereof was at most 6° C. Note that the drum 82 preferably has no surface defect. There were no pin holes having a diameter of 30 μm or more, at most one pin hole having a diameter in the range of 10 μm to 30 μm per square meter, and at most two pin holes having a diameter of less than 10 μm per square meter.

The oxygen concentration in the dry atmosphere on the drum 82 was kept at 5 vol %. In order to keep the oxygen concentration at 5 vol %, air was substituted by nitrogen gas. In order to condense and recover the solvent in the casting chamber 62, the condenser 87 was disposed therein and the outlet temperature of the condenser 87 was set to −3° C. The static pressure fluctuation at the vicinity of the casting die 81 was reduced to at most ±1 Pa.

The casting dope 51 was cast through the casting die 81 onto the circumferential surface 82b to form the casting film 53 thereon. The casting film 53 was cooled and solidified on the circumferential surface 82b, and then peeled from the drum 82 by the peel roller 83 to form the primary wet film 55. The peeling speed (peel roller draw) was appropriately regulated within the range of 100.1% to 110% relative to the moving speed of the drum 82 in order to prevent peeling defect. The substituent compound, having evaporated in the casting chamber 62, was condensed and liquefied by the condenser 87 set at approximately −3° C. to be recovered by the recovery device 88. The water content of the recovered solvent was reduced to at most 0.5%. The dry gas from which the solvent was removed was heated and reused as the dry gas.

The peel roller 83 guided the primary wet film 55 to the transfer section 63. The rollers 121a to 121c provided in the transfer section 63 guided the primary wet film 55 to the pin tenter 64. In the transfer section 63, the dry gas at approximately 60° C. was blown onto the primary wet film 55.

In the pin tenter 64, the primary wet film 55 passed through each section in the pin tenter 64 in a state that side edge portions thereof were supported by the pins. During conveyance in the pin tenter 64, a predetermined drying process was performed to the primary wet film 55. The temperature of the dry gas inside the pin tenter 64 was regulated at approximately 120° C. Thereafter, the primary wet film 55 was sent to the edge slitting device 65.

A condenser (not shown) was provided in the pint tenter 64 for the recovery of the solvent vapor. The solvent vapor evaporated in the pin tenter 64 was condensed and liquefied at the temperature of −3° C. The water content of the recovered solvent was reduced to at most 0.5 wt. % and reused.

The both side edge portions of the primary wet film 55 were cut off by the edge slitting device 65 at a position within 30 seconds from the exit of the pin tenter 64. With the NT cutter, both side edge portions of the primary wet film 55 each of which has the width of 50 μm from the edge in the width direction of the primary wet film 55 were cut off. The cut off edge portions were sent to the crusher 95 by the cutter blower (not shown). The crusher 95 pulverized the cut off side edge portions into chips of 80 mm² in average. The chips together with the TAC flakes were used as the raw material for the dope preparation.

Thereafter, the primary wet film 55 was sent to the first drying chamber 66. After being released from the edge slitting device 65, the primary wet film 55 had the residual solvent amount of approximately 10 wt. %. In the first drying chamber 66, the wet gas 400 was blown onto the primary wet film 55 to perform the first drying process 58 for a predetermined time SP1. Thereby, the primary wet film 55 was referred to as the secondary wet film 57. The secondary wet film 57 was sent to the second drying chamber 67.

The wet gas supplying device 125 recovered the gas in the first drying chamber as the recovered gas 300, and supplied the wet gas 400 to the first drying chamber 66 to keep the atmospheric conditions in the first drying chamber 66 constant. In the wet gas supplying device 125, the wet gas 400 was generated from the soft water 410 and the air 420. The temperature DT1 of the wet gas 400 was approximately 120° C., and the amount of the water vapor VM1 was 550 (g/m³). In this example, the time SP1 was 7 minutes.

In the second drying chamber 67, the dry gas at the temperature of approximately 140° C. was blown onto the secondary wet film 57 to perform the second drying process 60 for a predetermined time SP2. Thus, the film 59 was produced.

In the second drying chamber 67, the secondary wet film 57 was conveyed by the rollers at the tension of 100 N/m, and dried for approximately 5 minutes until the residual solvent amount of the secondary wet film 57 reaches 0.3 wt. %. Lap angles were in a range of 90° and 180°. The lap angle is an angle of a portion of the secondary wet film 57 contacting the roller. The material of the roller was aluminum or carbon steel, and the hard chrome plating was applied to the surface. The rollers with a flat surface and those with a dimple surface were used. The film position fluctuation of each roller caused by the rotation of the roller was at most 50 μm. Deflection of the roller at the tension of 100 N/m was at most 0.5 mm.

With the use of the adsorption and recovery device 101, the solvent vapor contained in the dry gas was recovered by adsorption and removed from the dry gas. The adsorbent was activated carbon, and a desorbent was dry nitrogen. The recovered solvent was reused as the solvent for the dope preparation after its water content was adjusted to at most 0.3 wt. %. The dry gas contained plasticizers, UV absorbing agents, and other high boiling point compounds in addition to the solvent vapor, and such substances were removed from the dry air by the cooler and the preadsorber. Thus, the dry air was recycled and circulated. The adsorption and desorption conditions were set such that the VOC (volatile organic compound) in the gas emission to the outside becomes at most 10 ppm. The amount of the solvent recovered by the condensing method occupies 90 wt. % of all solvent vapor. Most of the remaining solvent vapor was recovered by the adsorption.

The dried film 59 was conveyed to the first humidification chamber (not shown). The dry gas at 110° C. was supplied to the transfer section between the second drying chamber 67 and the first humidification chamber. Air at 50° C. and with the dew point of 20° C. was supplied to the first humidification chamber. Then, the film 59 was conveyed to the second humidification chamber (not shown) to prevent the curling of the film 59. In the second humidification chamber, air at 90° C. with the humidity of 70% was directly blown onto the film 59.

After the humidification, the film 59 was cooled in the cooling chamber 68 to 30° C. or below. Then, the both side edge portions of the film 59 were cut off by the edge slitting device (not shown). The compulsory neutralization device (neutralization bar) 104 was disposed so as to keep the charged voltage of the film 59 constantly in a range of −3 kV and 3 kV during the conveyance. Knurling was provided to both side edge portions of the film 59 by the knurling roller pair 105. In each of the side edge portions of the film 59, embossing processing was applied. The width to which the knurling was applied was 10 mm from each side edge of the film 59. The knurling pressure applied to the film 59 by the knurling roller pair 105 was set such that the embossing height was 12 μm larger in average than the average film thickness.

The film 59 was conveyed to the winding chamber 69. Inside the winding chamber 69, the temperature was kept at 28° C. and the humidity was kept at 70%. An ionizer (not shown) was installed in the winding chamber 69 to keep the charged voltage of the film 59 in a range of −1.5 kV and +1.5 kV. Lastly, the film 59 was wound by the winding roller 107 in the winding chamber 69 while predetermined tension is applied to the film 59 using the press roller 108.

### EXAMPLE 2

The film 59 was produced under the same conditions as those in the example 1 except that the amount of the water vapor VM1 contained in the wet gas 400 was 500 (g/m³).

### EXAMPLE 3

The film 59 was produced under the same conditions as those in the example 1 except that the amount of the water vapor VM1 contained in the wet gas 400 was 400 (g/m³).

### EXAMPLE 4

The film 59 was produced under the same conditions as those in example 1 except that the amount of the water vapor VM1 contained in the wet gas 400 was 300 (g/m³)

### COMPARATIVE EXAMPLE 1

The film was produced under the same conditions as those in the example 1, except that the dry gas with no water vapor was used instead of the wet gas 400 in the first drying chamber 66. The temperature of the dry gas in the first drying chamber 66 was set at 120° C., and the drying process was performed in the first drying chamber 66 for 7 minutes.

### EXAMPLE 5

The film 59 was produced under the same conditions as those in the example 1, except that the casting process 54 was performed so as to form the film 59 with the thickness TH1 of 80 μm, and the temperature DT1 of the wet gas 400 was approximately 140° C.

### EXAMPLE 6

The film 59 was produced under the same conditions as those in the example 5, except that the water vapor VM1 contained in the wet gas 400 was 500 (g/m³).

### EXAMPLE 7

The film 59 was produced under the same conditions as those in the example 5, except that the water vapor VM1 contained in the wet gas 400 was 400 (g/m³).

### EXAMPLE 8

The film 59 was produced under the same conditions as those in the example 1, except that the water vapor VM1 contained in the wet gas 400 was 300 (g/m³).

### COMPARATIVE EXAMPLE 2

The film was produced under the same conditions as those in the example 5, except that the dry gas with no water vapor was used instead of the wet gas 400 in the first drying chamber 66. The temperature of the dry gas in the first drying chamber 66 was 120° C., and the drying process was performed in the first drying chamber 66 for 7 minutes.

### COMPARATIVE EXAMPLE 3

The film was produced under the same conditions as those in the example 6, except that the casting process 54 was performed so as to form the film with the thickness TH1 of 10 μm.

### COMPARATIVE EXAMPLE 4

The film was produced under the same conditions as those in the comparative example 2, except that the casting process 54 was performed so as to form the film with the thickness TH1 of 10 μm.

### COMPARATIVE EXAMPLE 5

The film was produced under the same conditions as those in the comparative example 2, except that the drying process was performed in the first drying chamber 66 for 15 minutes.

### EXAMPLE 9

The film 59 was produced under the same conditions as those in the example 1, except that the wet gas supplying device 240 was used instead of the wet gas supplying device 125, and that methanol was used instead of water with a methanol content VM1 in the wet gas 402 of 900 g/m³.

### EXAMPLE 10

The film 59 was produced under the same conditions as those in the example 9, except that acetone was used instead of methanol with the acetone content VM1 of 1800 g/m³.

[Evaluation of the Film]

In the above examples, the residual solvent amount and the water content of the secondary wet film 57 discharged from the first drying chamber 66 were measured. The following measurements were applied to all the examples and the comparative examples. The results of the evaluation in the examples and the comparative examples are shown in Table 1 below. The numerals shown in the columns of the results of the evaluation correspond to the following numerals of evaluation items.

1. Measurement of Residual Solvent Amount

A small piece of the film (7 mm×35 mm) was cut from each of the films obtained in the examples and the comparative examples as a sample for measurement. The residual solvent amount of the sample was measured using a residual solvent vaporizer (a product of Teledyne Technologies Company or the former Teledyne Tekmar) and gas chromatography apparatus (a product of GL Sciences Inc.)

2. Measurement of Water Content in the Film

A small piece of the film (7 mm×35 mm) was cut from each of the films obtained in the examples and the comparative examples as a sample for measurement. The mass of the water content was measured by Carl Fisher method using a water vaporizing apparatus and a water content measurement device (a product of Metrohm Shibata Co. Ltd.). The water content in the film was calculated by dividing the measured weight of water content by a mass (g) of the sample.

TABLE 1

| | High | | | | | Results of | |
|---|---|---|---|---|---|---|---|
| | boiling | | | | | evaluation | |
| | point | TH1 | DT1 | SP1 | VM1 | 1 | 2 |
| | compound | (μm) | (° C.) | (min) | (g/m³) | (wt %) | (wt %) |
| E1 | water | 60 | 120 | 7 | 550 | 0.35 | 1.5 |
| E2 | water | 60 | 120 | 7 | 500 | 0.41 | 1.4 |
| E3 | water | 60 | 120 | 7 | 400 | 0.53 | 1.4 |
| E4 | water | 60 | 120 | 7 | 300 | 0.78 | 1.3 |
| CE1 | — | 60 | — | — | — | 1.0 | 1.3 |
| E5 | water | 80 | 140 | 7 | 550 | 0.45 | 1.5 |
| E6 | water | 80 | 140 | 7 | 500 | 0.51 | 1.5 |
| E7 | water | 80 | 140 | 7 | 400 | 0.69 | 1.4 |
| E8 | water | 80 | 140 | 7 | 300 | 0.91 | 1.4 |
| CE2 | — | 80 | — | — | — | 1.2 | 1.3 |
| CE3 | water | 10 | 140 | 7 | 500 | 0.21 | 1.5 |
| CE4 | — | 10 | — | — | — | 0.21 | 1.4 |
| CE5 | — | 80 | — | — | — | 0.60 | 1.6 |
| E9 | methanol | 60 | 120 | 7 | 900 | 0.80 | 1.3 |
| E10 | acetone | 60 | 120 | 7 | 1800 | 0.90 | 1.3 |

E1 to E10 denote the examples 1 to 10.
CE1 to CE5 denote the comparative examples 1 to 5.

According to the first drying process 58 and the second drying process 60 using the wet gas 400, the constituent compounds were released efficiently compared to the conventional drying processes. The constituent compounds were more easily released as the amount of the water vapor VM1 contained in the wet gas 400 increases. Since the water contents in the films obtained in the examples were approximately the same as those obtained in the comparative examples where the first drying process 58 was not performed, there were no residues of the high boiling compounds in the film 59 by the first drying process 58. In other words, there were no harmful effects caused by the high boiling compounds in the first drying process 58. The results show that the present invention is significantly effective for the films having the thickness larger than a predetermined value at the start of the first drying process 58. Thus, according to the present invention, thick films are efficiently produced.

Various changes and modifications are possible in the present invention and may be understood to be within the present invention.

What is claimed is:

1. A solution casting method comprising the steps of:
(a) casting a dope on a support to form a casting film on said support, said dope containing a polymer and a solvent;
(b) peeling said casting film as a wet film from said support, said casting film containing said solvent;
(c) eliminating a first compound from said wet film by contacting said wet film with gas for drying said wet film to form a film, said gas containing a second compound having a higher boiling point than said first compound contained in said solvent.

2. The solution casting method of claim 1, wherein said solvent contains plural compounds, and said compound having a highest boiling point among said plural compounds to be eliminated is defined as said first compound.

3. The solution casting method of claim 1, wherein said gas contains said second compound having at least 0.3 MS and at most 1 MS where MS is an amount of saturated vapor in said second compound.

4. The solution casting method of claim 1, wherein a temperature of said gas is at least BP and at most 3 BP where BP (unit: ° C.) is a boiling point of said second compound.

5. The solution casting method of claim 1, wherein said first compound contains at least one of dichloromethane, methanol, and ethanol, and said second compound contains at least one of water, methanol, acetone, methyl ethyl ketone, and butanol.

6. The solution casting method of claim 1, wherein said step (c) is performed after said wet film is dried using a tenter drier.

7. The solution casting method of claim 1 further comprising a step of:
(d) blowing heated gas onto said wet film for drying said wet film after said step (c).

8. A solution casting method comprising the steps of:
(a) casting a dope on a support to form a casting film on said support, said dope containing a polymer and a solvent;
(b) peeling said casting film as a wet film from said support, said casting film containing said solvent;
(c) contacting at least one of said casting film and said wet film with a liquid, said casting film and said wet film containing a first compound contained in said solvent, said liquid containing a second compound having a higher boiling point than said first compound; and
(d) eliminating said first compound from said wet film by drying said wet film to form a film after said step (c).

9. A solution casting apparatus comprising:
a support on which a casting film is formed, said casting film containing a polymer and a solvent;
a peeling device for peeling said casting film as a wet film from said support; and
a drying device for eliminating a first compound contained in said solvent from said wet film by drying said wet film with gas containing a second compound, said second compound having a higher boiling point than said first compound contained in said solvent.

10. The solution casting apparatus of claim 9, wherein said drying device includes a plurality of rollers for conveying said wet film, a drying chamber in which said rollers are housed, and a gas supplying unit for circulating said gas to and from said drying chamber.

11. The solution casting apparatus of claim 9 further including a tenter dryer which holds side edge portions of said wet film and conveys said wet film while blowing gas onto said wet film, said tenter dryer being disposed upstream from said drying device.

12. The solution casting apparatus of claim 9 further including a heated-gas drying device for blowing heated gas onto said wet film after said wet film passes through said drying device, said heat-gas drying device being disposed downstream from said drying device.
